(19) United States
(12) Patent Application Publication
(10) Pub. No.: US 2011/0316810 A1
(43) Pub. Date: Dec. 29, 2011

(54) DISPLAY DEVICE WITH TOUCH PANEL

(75) Inventors: Kazuya Tsujino, Osaka (JP); Keiichi Yamamoto, Osaka (JP)

(73) Assignee: SHARP KABUSHIKI KAISHA, Osaka (JP)

(21) Appl. No.: 13/201,184

(22) PCT Filed: Oct. 14, 2009
(86) PCT No.: PCT/JP2009/005364

§ 371 Date: Aug. 11, 2011

(30) Foreign Application Priority Data
Feb. 20, 2009 (JP) 2009-037878

(51) Int. Cl. G06F 3/045; G09G 3/36

(52) U.S. Cl. 345/174; 345/87

(57) ABSTRACT

A liquid crystal display device 1 with a touch panel is provided with the following: a TFT substrate 2 having a terminal 11 to which an alternating current voltage for position detection is supplied; a CF substrate 3 disposed to face the TFT substrate 2; a liquid crystal layer 4 disposed between the TFT substrate 2 and the CF substrate 3; and a transparent conductive film 6 for a touch panel disposed on the opposite surface of the CF substrate 3 from the liquid crystal layer 4 side. The CF substrate 3 has a through hole 14 and a first conductive member 15 disposed in the through hole 14. A second conductive member 16 is disposed between the terminal 11 and the first conductive member 15. The transparent conductive film 6 and the terminal 11 are electrically connected to each other through the first conductive member 15 and the second conductive member 16.

### TECHNICAL FIELD

The present invention relates to a display device provided with a touch panel that can detect a position on a display surface contacted by a finger, a pen or the like.

### BACKGROUND ART

In recent years, touch panels (or touch sensors), which are devices for operating electronic devices by touching the surface, have been provided in electronic devices such as automatic vending machines, ATMs, portable game devices, car navigation systems, and the like. These touch panels are devices that input information to electronic devices interactively when they are touched (pressed) with a finger, a pen, or the like.

These touch panels are classified into a resistive film type, a capacitance coupling type, an infrared type, an ultrasonic type, an electromagnetic inductive coupling type, and the like according to their operating principle. In recent years, resistive film type and capacitance coupling type touch panels have been widely used because they can be applied to display devices and the like at a low cost. Particularly, the capacitance coupling type touch panel that has high transmittance and high durability has been attracting attention.

When a touch panel is combined with a display device, the touch panel is disposed on the front surface (viewer side) of the display device such as a liquid crystal display device and the like, for example. More specifically, as shown in FIGS. 12 and 13, for example, there has been disclosed a liquid crystal display device 55 with a touch panel provided with a TFT (Thin-Film Transistor) substrate 50 that is a first substrate, a CF (Color Filter) 51 that is a second substrate disposed on the viewer side, and liquid crystal (not shown in the figure) that is disposed between the TFT substrate 50 and the CF substrate 51. In addition, this liquid crystal display device 55 with a touch panel is provided with a transparent conductive film 53 that is disposed on the opposite surface of the CF substrate 51 from the side having liquid crystal and that is used as a transparent electrode of the capacitance coupling type touch panel, and a polarizing plate 54 disposed on the transparent conductive film 53. In this liquid crystal display device 55 with a touch panel, as shown in FIG. 12, terminals 56 to which an alternating current voltage for position detection is supplied are disposed on the TFT substrate 50, and these terminals 56 and the four corners of the transparent conductive film 53 are electrically connected by a conductive tape 57.

Here, two corners (two locations) of the four corners of the transparent conductive film 53 are far from the terminals 56. Therefore, relay terminals 58 disposed on the TFT substrate 50 and the conductive tape 57 are electrically connected, and the relay terminals 58 and a wiring 60 are electrically connected, thereby connecting the relay terminals 58 and the terminals 56 with the conductive tape 57 and the wiring 60. Therefore, in order to enable such a configuration, the substrate width W₂ of the CF substrate 51 is narrower than the substrate width W₁ of the TFT substrate 50, and three sides of the CF substrate 51 are narrower compared to the TFT substrate 50 (see Patent Document 1, for example).

In a capacitance coupling type touch panel, when an alternating current voltage is applied to the terminals 56 for position detection and a contact point is formed on the transparent conductive film 53 with a finger, a pen, or the like, the transparent conductive film 53 is capacitively coupled with the ground (contact surface). Position coordinates of the contact position are obtained by detecting an electric current value flowing between the contact position that is capacitively connected and the terminals 56.

### Related Art Document

### Patent Document

Patent Document 1: Japanese Patent Application Laid-Open Publication No. 2008-134522

### SUMMARY OF THE INVENTION

### Problems to be Solved by the Invention

However, in the liquid crystal display device 55 with a touch panel according to the aforementioned Patent Document 1, as shown in FIG. 13, a step is formed between the transparent conductive film 53 and the terminal 56 that are electrically connected with the conductive tape 57. In addition, as the conductive tape 57 needs to be attached to this step part, there has been a problem of decreasing connection reliability because it is difficult to attach the conductive tape 57 as well as to electrically connect the transparent conductive film 53 and the terminal 56.

Furthermore, as described above, because three sides of the CF substrate 51 need to be formed narrower compared to the TFT substrate 50, a step of cutting the CF substrate 51 is added, causing a problem of increasing cost.

Thus, the present invention seeks to address the aforementioned problems, and has an object of providing a display device with a touch panel that ensures electric connection between terminals and a transparent conductive film and that can avoid cost increase.

### Means of Solving the Problems

In order to achieve the aforementioned object, the display device with a touch panel according to the present invention is provided with a first substrate having a terminal to which an alternating current voltage for position detection is supplied, a second substrate that is disposed to face the first substrate, a display medium layer that is disposed between the first substrate and the second substrate, a sealing material in a frame shape disposed between a first member and a second member for attaching the first substrate and the second substrate together and for encapsulating the display medium layer, and a transparent conductive film for the touch panel that is disposed on the opposite surface of the second substrate from the display medium layer side. The second substrate has a through hole and a first conductive member disposed in the through hole for connecting the transparent conductive film and the terminal, and a second conductive member is disposed between the terminal and the first conductive member for connecting the transparent conductive film to the terminal. The transparent conductive film and the terminal are electrically connected through the first conductive member and the second conductive member.

According to this configuration, unlike the aforementioned conventional art, terminals to which the alternating current voltage for position detection is supplied and the transparent conductive film for the touch panel can be connected without attaching a conductive tape on the step part formed between the transparent conductive film and the terminals. As a result, the terminals and the transparent conductive film can be electrically connected to each other securely, and connection reliability can be improved.

Unlike the aforementioned conventional case in which a conductive tape is used, because three sides of the second substrate do not have to be made narrower compared to the first substrate, adding a step of cutting the second substrate can be avoided, and costs can be reduced.

In addition, unlike the conductive tape used in the aforementioned conventional art, because the first conductive member is disposed in the through hole formed in the second substrate, and because the first conductive member is configured to be embedded in the second substrate, corrosion of the first conductive member can be effectively prevented. As a result, stable electric connection can be obtained between the transparent conductive film and terminals, and connection reliability can be improved.

In the display device with a touch panel of the present invention, the second conductive member may be made of a conductive material containing a resin and conductive particles coated with the resin.

According to this configuration, because conductive particles are coated with the resin, corrosion of the second conductive member can be effectively prevented. As a result, even more stable electric connection can be obtained between the transparent conductive film and terminals, and connection reliability can be improved further.

The display device with a touch panel of the present invention may be configured such that the resin is a sealing resin for forming a sealing material and that the sealing material also serves as the second conductive member.

According to this configuration, because the second conductive member can be relocated to the liquid crystal layer side without being disposed outside the sealing material, the area of a frame region in the liquid crystal display device with a touch panel can be reduced. In addition, because the sealing material and the second conductive member do not need to be formed separately, the number of components is reduced, and cost can be decreased.

In the display device with a touch panel of the present invention, the second conductive member may be disposed between the sealing material and the liquid crystal layer.

According to this configuration, because the second conductive member can be moved to the liquid crystal layer side, the area of the frame region in the liquid crystal display device with a touch panel can be reduced.

In the display device with a touch panel of the present invention, the first conductive member may be made of a conductive paste containing a conductive filler and a binder resin.

In the display device with a touch panel according to the present invention, the first conductive member may be made of a metal.

The display device with a touch panel of the present invention has excellent characteristics that connection reliability is improved by securely connecting the terminal to the transparent conductive film and cost is reduced by avoiding an additional step of cutting the second substrate. Therefore, the display device with a touch panel of the present invention is suited for a display device with a touch panel having a liquid crystal layer as a display medium layer.

### Advantages of the Invention

According to the present invention, in a display device with a touch panel, connection reliability between terminals and a transparent conductive film can be improved, and cost can be reduced.

### BRIEF DESCRIPTION OF THE DRAWINGS

FIG. 1 is an oblique perspective view showing a liquid crystal display device with a touch panel according to Embodiment 1 of the present invention.

FIG. 2 is a cross-sectional view showing the liquid crystal display device with a touch panel according to Embodiment 1 of the present invention.

FIG. 3 is a plan view to explain a TFT substrate of the liquid crystal display device with a touch panel according to Embodiment 1 of the present invention.

FIG. 4 is a plan view to explain the liquid crystal display device with a touch panel according to Embodiment 1 of the present invention.

FIG. 5 is a cross-sectional view along the lengthwise direction of the liquid crystal display device with a touch panel according to Embodiment 1 of the present invention, and is a cross-sectional view along the line A-A of FIG. 4.

FIG. 6 is a cross-sectional view along the widthwise direction of the liquid crystal display device with a touch panel according to Embodiment 1 of the present invention, and is a cross-sectional view along the line B-B of FIG. 4.

FIG. 7 is a drawing to explain the basic principles of a position detection method by capacitance coupling in Embodiment 1 of the present invention.

FIG. 8 is a cross-sectional view along the lengthwise direction of a liquid crystal display device with a touch panel according to Embodiment 2 of the present invention.

FIG. 9 is a cross-sectional view along the widthwise direction of the liquid crystal display device with a touch panel according to Embodiment 2 of the present invention.

FIG. 10 is a cross-sectional view along the lengthwise direction of a liquid crystal display device with a touch panel according to Embodiment 3 of the present invention.

FIG. 11 is a cross-sectional view along the widthwise direction of the liquid crystal display device with a touch panel according to Embodiment 3 of the present invention.

FIG. 12 is a plan view to explain a conventional liquid crystal display device with a touch panel.

FIG. 13 is a cross-sectional view to explain the conventional liquid crystal display device with a touch panel.

### DETAILED DESCRIPTION OF EMBODIMENTS

### Embodiment 1

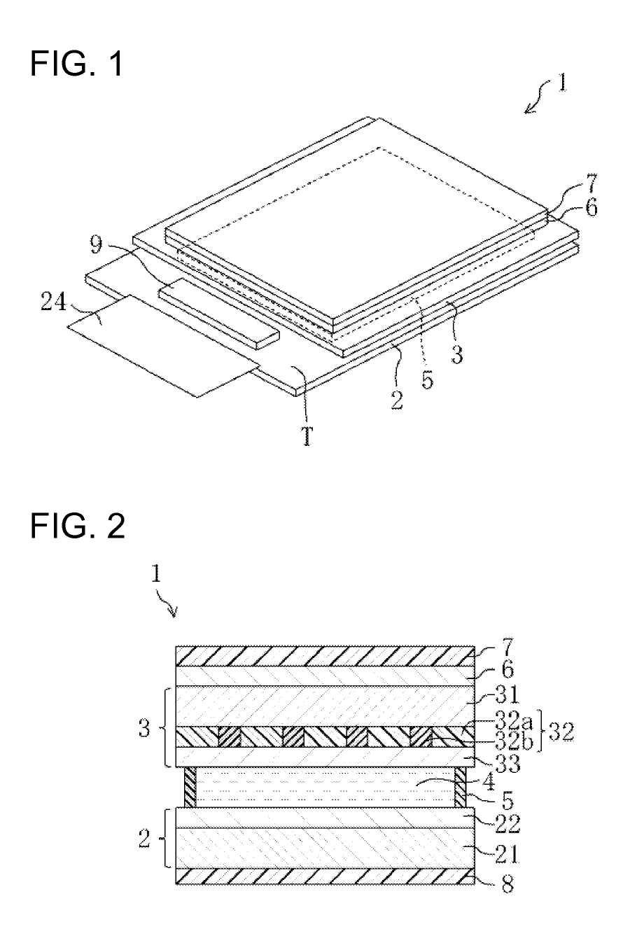

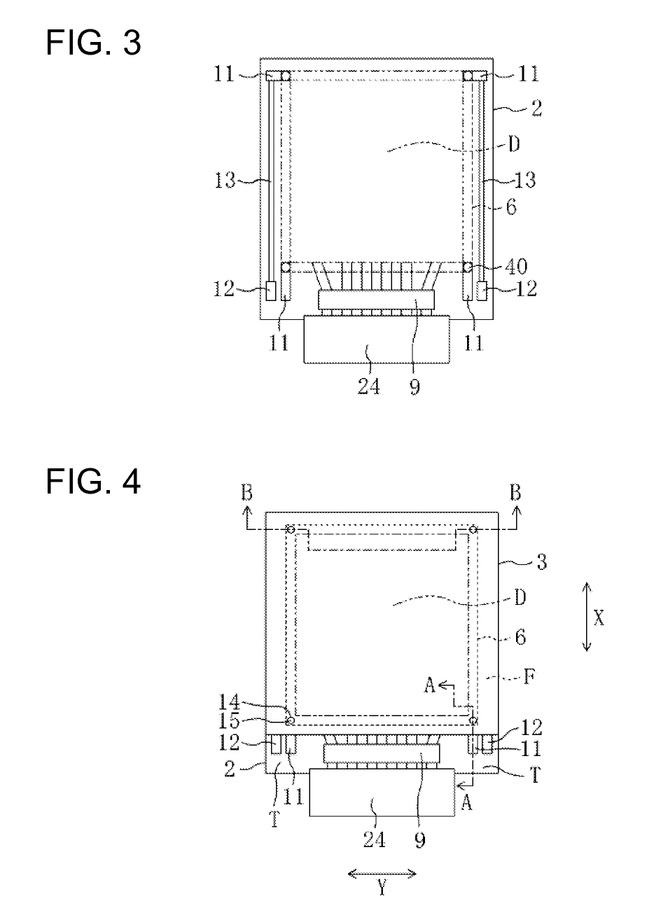

Embodiments of the present invention are explained in detail below based on the figures. In these embodiments, a liquid crystal display device is used as an example of a display device. FIG. 1 is an oblique perspective view showing a liquid crystal display device with a touch panel according to Embodiment 1 of the present invention, and FIG. 2 is a cross-sectional view showing the liquid crystal display device with a touch panel according to Embodiment 1 of the present invention. FIG. 3 is a plan view to explain a TFT substrate of the liquid crystal display device with a touch panel according to Embodiment 1 of the present invention. FIG. 4 is a plan view to explain the liquid crystal display device with a touch panel according to Embodiment 1 of the present invention. In FIG. 4, to facilitate explanation, a transparent conductive film 6 is shown by a dashed line 6, and a polarizing plate is not shown in the figure.

As shown in FIGS. 1 and 2, a liquid crystal display device 1 is provided with a TFT substrate 2 that is the first substrate having a plurality of TFTs (Thin Film Transistors) that are switching elements thereon and a CF substrate 3 that is the second substrate disposed to face the TFT substrate 2. In addition, the liquid crystal display device 1 is provided with a liquid crystal layer 4 that is a display medium layer disposed between the TFT substrate 2 and the CF substrate 3, as well as a sealing material 5 of a frame shape disposed between the TFT substrate 2 and the CF substrate 3 for attaching the TFT substrate 2 and the CF substrate 3 together and for encapsulating the liquid crystal layer 4. The sealing material 5 is formed to encircle the liquid crystal layer 4, and the TFT substrate 2 and the CF substrate 3 are attached to each other through this sealing material 5. The TFT substrate 2 and the CF substrate 3 are respectively formed in a shape of a rectangular plate. Furthermore, the liquid crystal display device 1 is provided with a plurality of photospacers (not shown in the figure) for controlling the thickness (thus, a cell gap) of the liquid crystal layer 4.

Furthermore, in the liquid crystal display device 1, as shown in FIG. 4, a display region (central region) D for displaying image is provided in a region on the inner side of the sealing material 5 where the TFT substrate 2 and the CF substrate 3 overlap with each other. Here, in the display region D, a plurality of pixels, which are the smallest unit of an image, are formed and arranged in a matrix. Furthermore, in the periphery of the display region D, a frame region F having four sides where the sealing material 5 is disposed and a terminal region T that is a portion of the TFT substrate 2 exposed from the CF substrate 3 (i.e., the lower portion of the TFT substrate 2 projecting from the CF substrate 3) are provided. The liquid crystal display device 1 has a so-called “three-free-sides configuration” in which the terminal region T is provided along one side of the TFT substrate 2 and is disposed only on this one side.

The liquid crystal display device 1 is provided with a transparent conductive film 6 for a touch panel that forms a capacitance-type touch panel on the opposite surface of the CF substrate 3 from the liquid crystal layer 4 side. This transparent conductive film 6 for the touch panel forms the capacitance coupling type touch panel having the outer surface of a polarizing plate 7 disposed on a surface of the transparent conductive film 6 as a contact surface.

As shown in FIG. 2, a polarizing plate 8 is provided on the opposite surface of the TFT substrate 2 from the liquid crystal layer 4 side.

The TFT substrate 2 is provided with an insulating substrate 21 such as a glass substrate or the like, a TFT array layer 22 disposed on the insulating substrate 21, and an alignment film (not shown in the figure) disposed on the TFT array layer 22. Here, the TFT array layer 22 is provided with a plurality of gate lines (not shown in the figure) that extend parallel to each other on the insulating film 21, a plurality of source lines (not shown in the figure) that extend parallel to each other so that they are perpendicular to the respective gate lines, a plurality of TFTs (not shown in the figure) that are provided at the respective intersections of the gate lines and the source lines, and a plurality of pixel electrodes (not shown in the figure) that are connected to the respective TFTs.

The CF substrate 3 is provided with an insulating substrate 31 such as a glass substrate or the like, a color filter layer 32 disposed on the insulating substrate 31, an overcoat layer (not shown in the figure) disposed on the color filter layer 32, a common electrode 33 disposed on the overcoat layer, and an alignment film (not shown in the figure) disposed on the common electrode 33.

The color filter layer 32 is provided with a plurality of colored layers 32a that are colored red, green, or blue corresponding to the respective pixel electrodes on the TFT substrate 2 and a black matrix 32b disposed between the respective colored layers 32a.

The liquid crystal layer 4 includes, for example, nematic liquid crystal having an electrooptic property.

The transparent conductive film 6 for a touch panel is formed of ITO (Indium Tin Oxide), IZO (Indium Zinc Oxide), an organic conductive material, or the like, for example.

The polarizing plates 7 and 8 are optical sheets having the function of only transmitting a polarization component of incident light that is in a specific direction.

As shown in FIG. 1, in the terminal region T of the TFT substrate 2, an integrated circuit chip (or an IC chip) 9, which is an electronic component, as well as a flexible printed board 24, which is connected to the integrated circuit chip 9 for supplying an external signal through a wiring, are provided.

Furthermore, as shown in FIG. 3, the TFT substrate 2 is provided with a plurality (four in this embodiment) of terminals 11 to which an alternating current voltage for position detection is supplied. These terminals 11 are disposed corresponding to the four corners of the transparent conductive film 6.

Furthermore, through the integrated circuit chip 9 or not through the integrated circuit chip 9, the terminals 11 are connected to a driver circuit chip (not shown in the figure) that includes an alternating current voltage generating circuit disposed on the flexible printed board 24 through the flexible printed board 24. The terminals 11 are electrically connected to an external power source (not shown in the figure) through the flexible printed board 24.

Furthermore, among the four terminals 11, two terminals 11 that are remote from the terminal region T (i.e., the two terminals 11 that are disposed in the upper part of FIG. 3) are electrically connected to relay terminals 12 disposed on the TFT substrate 2 through wires 13.

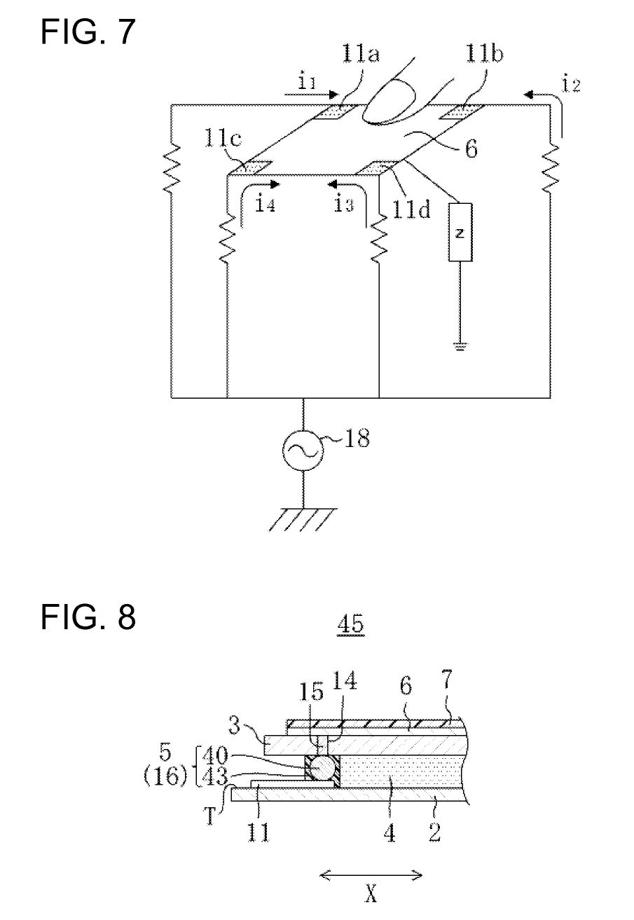

Next, referring to FIG. 7, the basic principles of a position detection method by capacitance coupling used in the present invention are briefly explained.

On the transparent conductive film 6 for position detection, terminals 11a, 11b, 11c, and 11d for position detection are formed at four corners. Through terminals 11a, 11b, 11c, and 11d, the alternating current voltage for position detection is supplied to the transparent conductive film 6 from an alternating current voltage generating circuit 18. Here, the example shown uses the common alternating current voltage generating circuit 18 for the four terminals 11a, 11b, 11c, and 11d. However, the present invention is not limited thereto as long as an alternating current voltage of the same potential with the same phase is applied. In addition, if there are at least two terminals, a position between the terminals can be obtained.

A contact point is formed on the transparent conductive film 6 when a finger, a pen, or the like touches or approaches sufficiently close to a surface of the transparent conductive film 6 of the liquid crystal display device 1 with a touch panel, or a surface of a protective layer disposed on the viewer side of the transparent conductive film 6. In this specification, this may be expressed as “a contact point is directly or indirectly formed on the transparent conductive film 6.”

When a contact point is formed on the transparent conductive film 6, the transparent conductive film 6 becomes capacitively coupled with the ground (contact surface). This capacitance is, for example, a combination of a capacitance between the protective layer and the transparent conductive film 6 and impedance existing between the operator and the ground.

The values of the electrical resistances between the contact position that is capacitively coupled and the terminals 11a, 11b, 11c, and 11d on the four corners of the transparent conductive film 6 are proportional to the respective distances between the contact position and the respective terminals. Therefore, electric currents that are generally inversely proportional to the respective distances between the contact position and the terminal flows through the respective terminal 11a, 11b, 11c, and 11d at the four corners of the transparent conductive film 6. The positional coordinates of the contact position can be obtained by detecting the amounts of these electric currents (relative values).

The electric currents flowing at the four corners of the transparent conductive film 6 generated by a contact with a finger and the like are referred to as i₁, i₂, i₃, and i₄, respectively (see FIG. 7). Here, for simplicity, it is assumed that the electric currents do not flow when a contact point is not formed on the transparent conductive film 6. However, in reality, because the electric current flows through a floating capacitance even when a contact point is not formed, the change in the amount of electric currents (increased amounts) generated when a contact point is formed needs to be obtained for position detection.

The X coordinate and the Y coordinate of a contact position of the transparent conductive film 6 can be determined based on the following formulas.

X=k₁+k₂·(i₂+i₃)/(i₁+i₂+i₃+i₄) (Formula 1)

Y=k₁+k₂·(i₁+i₂)/(i₁+i₂+i₃+i₄) (Formula 2)

Also, the following formulas may be used.

X=k₁+k₂·(i₂/(i₂+i₄)+i₃/(i₁+i₃)) (Formula 3)

Y=k₁+k₂·(i₁/(i₁+i₃)+i₂/(i₂+i₄)) (Formula 4)

Here, X represents the X coordinate of a contact position on the transparent conductive film 6, and Y represents the Y coordinate of the contact position on the transparent conductive film 6. k₁ is an offset (0when an output coordinate is the origin), and k₂ is a magnification. k₁ and k₂ are constants that do not depend on the impedance of the operator.

Assume that the center of the position detection region is the origin. Then, formulas 1 to 4 can be represented as formulas 5 to 8.

X=k·(i₂+i₃−i₁−i₄)/(i₁+i₂+i₃+i₄) (Formula 5)

Y=k·(i₁+i₂−i₃−i₄)/(i₁+i₂+i₃+i₄) (Formula 6)

The following formulas may be used instead.

X=k·((i₂−i₄)/(i₂+i₄)−(i₁−i₃)/(i₁+i₃)) (Formula 7)

Y=k·((i₁−i₃)/(i₁+i₃)+(i₂−i₄)/(i₂+i₄)) (Formula 8)

Therefore, the contact position on the transparent conductive film 6 can be obtained from measured values of i₁, i₂, i₃, and i₄ that flow through the four terminals 11a, 11b, 11c, and 11d, respectively. However, when sufficient coordinate accuracy cannot be obtained solely by these formulas, calculation of higher order correction is performed as needed.

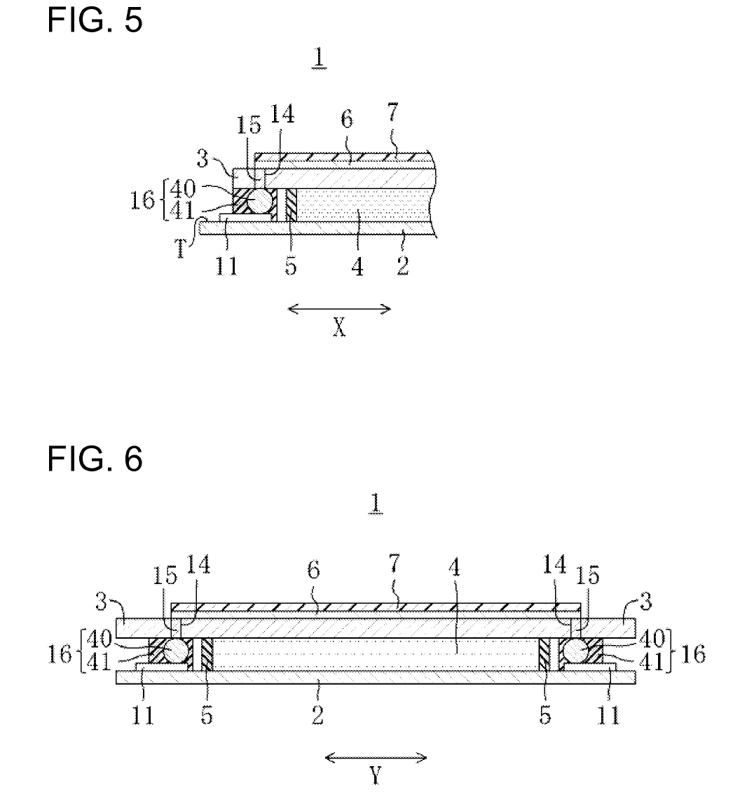

FIG. 5 is a cross-sectional view along the lengthwise direction (thus, the direction of an arrow X shown in FIG. 4) of the liquid crystal display device with a touch panel of Embodiment 1 of the present invention, and is a cross-sectional view along the line A-A of FIG. 4. FIG. 6 is a cross-sectional view along the widthwise direction (i.e., the direction of the arrow Y shown in FIG. 4) of the liquid crystal display device with a touch panel of Embodiment 1 of the present invention, and is a cross-sectional view along the line B-B of FIG. 4.

This embodiment is characterized by the features that the transparent conductive film 6 for a touch panel is electrically connected to terminals 11 through conductive members. More specifically, as shown in FIGS. 4 to 6, the CF substrate 3 is provided with through holes 14, and the through holes 14 are provided with first conductive members 15, respectively, for connecting the transparent conductive film 6 for a touch panel to the terminals 11. In addition, as shown in FIGS. 5 and 6, a second conductive member 16 for connecting the transparent conductive film 6 for a touch panel to the terminals 11 are disposed between the first conductive member 15 and the terminals 11.

The transparent conductive film 6 is electrically connected to the terminals 11 through the respective first conductive members 15 and the respective second conductive members 16. According to such a configuration, unlike the aforementioned conventional art, the terminals 11 and the transparent conductive film 6 can be connected securely because terminals 11 and the transparent conductive film 6 do not have to be electrically connected through a conductive tape attached to the step part formed between the terminals 11 and the first conductive member 15.

Furthermore, unlike the aforementioned conventional art, because this embodiment does not use a conductive tape, three sides of a CF substrate do not have to be formed narrower compared to the TFT substrate, and because the CF substrate 3 can be formed narrower compared to the TFT substrate 2 only in the terminal region T as shown in FIG. 4, adding a step of cutting the CF substrate 3 can be avoided.

In the aforementioned conventional art, there has been a problem of corrosion of the conductive tape because the conductive tape is exposed.

In contrast, unlike the conductive tape in the aforementioned conventional art, in this embodiment, the first conductive member 15 is provided in the through hole 14 formed in the CF substrate 3, and the first conductive member 15 is embedded in the CF substrate 3. Therefore, corrosion of the first conductive member 15 can be effectively prevented.

The through holes 14 are formed in the CF substrate 3 by a laser method using UV laser irradiation or a sandblasting method, for example. As shown in FIGS. 5 and 6, the through holes 14 are formed at locations that are outside the sealing material 5 in the lengthwise and widthwise directions X and Y of the liquid crystal display device 1 (i.e., the opposite side of the sealing material 5 from the liquid crystal layer 4 side) and that do not have a common electrode disposed on the CF substrate 3. As shown in FIG. 4, the through holes 14 are formed corresponding to the four corners of the transparent conductive film 6. The diameter of the through holes 14 is not particularly limited. However, it is preferably at least 100 μm but no more than 300 μm. The through holes 14 may be formed in a shape of a column or a rectangular column.

The first conductive member 15 may be made of a conductive paste containing a conductive filler and a binder resin, for example. As the conductive filer, metal powder with a low volume resistivity, such as silver powder, platinum powder, gold powder, copper powder, nickel powder, aluminum powder, and the like, as well as carbon powder, such as carbon black and the like, may be used, for example. As the binder resin, an epoxy resin, a polyester resin, a polyimide resin, and the like may be used, for example. These resins may be used individually as a binder resin, or two or more kinds may be combined and used as the binder resin.

In this embodiment, a liquid epoxy resin having at least two epoxy groups can be used as the binder resin, and a conductive paste using silver powder that has an average particle diameter of at least 0.1 μm but no more than 20 μm can be used as the conductive filler. Such a conductive paste having a thermosetting resin, such as the epoxy resin and the like, as the binder resin can be cured at a temperature of about 200° C., and a simple device such as an oven, for example, can be used to cure the conductive paste. The conductive paste can fill the through holes 14 by a screen printing method, for example.

Alternatively, as the first conductive member 15, a metal, such as gold, silver, copper, aluminum, and the like, can be used. Such a metal can fill the through holes 14 by electrolytic plating, for example.

As shown in FIGS. 5 and 6, the second conductive member 16 can be made of a conductive material such as a common transfer material, for example, containing a conductive particle 40 and a resin 41 where the conductive particle 40 is coated with the resin 41.

By using such a conductive material, because the conductive particle 40 is coated with the resin 41, corrosion of the second conductive member 16 can be effectively prevented.

As the conductive particle 40, a metal particle or plastic particle plated with a metal, a combination of these, or the like can be used, for example. As the resin 41, a thermosetting resin can be used, for example. As this thermosetting resin, a phenol resin, a urea resin, a melamine resin, an unsaturated polyester resin, an epoxy acrylate resin, a diallyl phthalate resin, an epoxy resin, a combination of these, or the like may be used, for example. As the epoxy resin, a cresol novolac epoxy resin, a bisphenol A epoxy resin, a bisphenol F epoxy resin, a combination of these, or the like can be used, for example.

Next, a method for manufacturing the liquid crystal display device with a touch panel of this embodiment is explained using an example. The manufacturing method of this embodiment includes the following steps: a step of manufacturing a TFT substrate; a step of manufacturing a CF substrate; a step of forming a through hole, a step of forming conductive members, a step of forming a transparent conductive film; and a step of attaching the substrates together.

Step of manufacturing a TFT substrate

First, on the insulating substrate 21 such as a glass substrate or the like, for example, TFTs, pixel electrodes, and the like are patterned, and the TFT array layer 22 that constitutes a display region is formed. Then, a polyimide resin is applied on the overall substrate by a printing method, and an alignment film is formed by a rubbing treatment. Here, the terminals 11, the terminals 12 and the wires 13 are formed monolithically by a widely known method.

Also, as a pretreatment prior to the step of attaching the substrates together, which will be described later, a resin (an ultraviolet curable resin, for example) to be used for tentatively attaching substrates together may be applied in a small amount on edges of the insulating substrate 21 using a dispenser.

Next, a spacer is formed by applying spherical silica or plastic particles, for example, on the overall substrate.

As described above, the TFT substrate 2 can be prepared.

Step of manufacturing a CF substrate

First, on an insulating substrate 31 such as a glass substrate or the like, for example, the colored filter layer 32 including the colored layer 32a and the black matrix 32b, the overcoat layer, the common electrode 33, and the like are patterned to form a CF element layer that forms the display region. Next, a polyimide resin is applied on the overall substrate by a printing method, and the alignment film is formed by a rubbing treatment. This completes the manufacture of the CF substrate 3. The black matrix 32b is made of a metal material such as Ta (tantalum), Cr (chromium), Mo (molybdenum), Ni (nickel), Ti (titanium), Cu (copper), Al (aluminum), and the like, a resin material having a black pigment, such as carbon or the like dispersed therein, or a resin material having laminated colored layers of a plurality of colors that transmit light.

Step of forming a through hole

Next, through holes 14 are formed in the manufactured CF substrate 3 by a laser method using UV laser irradiation or a sandblasting method, for example. As described above, the through holes 14 are formed corresponding to the four corners of the transparent conductive film 6.

When the through holes 14 are formed by the sandblasting method, first, a photosensitive resin is applied on a surface of the CF substrate 3. Then, the photosensitive resin is patterned so as to expose regions where the through holes 14 are to be formed, thereby forming a resist layer. Then, abrasive particles made of alumina, silicon carbide, and the like are sprayed by compressed air to the CF substrate 3 having this resist layer thereon. Through holes 14 having a diameter of at least 100 μm but no more than 300 μm, for example, can be formed by this method.

When the through holes 14 are formed by the laser method, the CF substrate 3 is irradiated with a UV laser, for example (KrF excimer laser having a wavelength of 248 nm, for example). Through holes 14 having a diameter of 100 μm, for example, can be formed by this method.

Step of forming a conductive member

Next, the first conductive member 15 is formed in the through holes 14 that are formed in the CF substrate 3. In the case that the first conductive members 15 are to be formed of a conductive paste containing a conductive filler and a binder resin, the plurality of through holes 14 are filled with the conductive paste by a screen printing method at once. Then, the conductive paste is cured by heating it at a prescribed temperature (200° C. when an epoxy resin is used as a binder resin, for example) to form the first conductive members 15 in the respective through holes 14. In the case that the first conductive members 15 are to be formed of a metal using an electrolytic plating method, first, a copper foil, for example, is attached to one surface of the CF substrate 3 having through holes 14 therein, and the copper foil is retained there using a prescribed jig. Next, the CF substrate 3 having the copper foil attached thereon is placed in an electrolytic plating device having plating liquid (copper sulfate, for example). Then, using the copper foil as a power supply electrode (cathode) of electrolytic plating, an electric current is applied between the cathode and the anode that is disposed separately in plating liquid to cause a reduction reaction of metal (i.e., copper) on the cathode. As a result, metal (i.e., copper) is deposited and fills the through holes 14 to form the first conductive members 15 in the respective through holes 14. After the first conductive members are formed, the copper foil is detached from the CF substrate 3 by removing the jig.

Then, a conductive material containing a conductive particle 40 and the resin 41 is applied on terminals 11 formed on the TFT substrate 2 to form second conductive members 16 on the respective terminals 11.

Step of forming a transparent conductive film

Next, an ITO film, for example, is formed by a sputtering method on the CF substrate 3 having the through holes 14 and the first conductive members 15 therein. Then, the ITO firm is patterned by photolithography to form the transparent conductive film 6 for a touch panel, which constitutes a capacitance-type touch panel, on the opposite surface of the CF substrate 3 from the liquid crystal layer 4 side. Here, the transparent conductive film 6 is formed to cover the through holes 14 formed in the CF substrate 3 as well as the first conductive members 15 formed in the through holes 14.

Step of attaching substrates together

First, the sealing material 5 formed of an ultraviolet curable thermosetting resin and the like is drawn in a frame shape using a dispenser, for example, on the CF substrate 3 having through holes 14 and the first conductive members 15 therein.

Next, a liquid crystal material is dropped onto the region on the inner side of the sealing material 5 on the CF substrate 3 having the aforementioned sealing material 5 drawn thereon.

Then, the CF substrate 3 onto which the aforementioned liquid crystal material has been dropped and the TFT substrate 2 having the second conducive members 16 formed thereon are attached together under a reduced pressure. Here, in order to connect the transparent conductive film 6 to the terminals 11 through the first conductive members 15 and the second conductive members 16, respectively, the first conductive members 15 (or through holes 14) on the CF substrate 3 and the second conductive members 16 on the TFT substrate 2 are aligned with each other while the TFT substrate 2 and the CF substrate 3 are being brought together to face each other, and then, the TFT substrate 2 and the CF substrate 3 are attached together.

Next, the substrates attached together are exposed to the atmospheric pressure, and the front surface and the back surface of this attached unit are pressurized. Then, the sealing material 5 disposed between the two substrates of the attached unit is irradiated with UV light, and is thereafter heated to cure the sealing material 5.

Then, the polarizing plate 7 is disposed on the surface of the transparent conductive film 6, and the polarizing plate 8 is formed on the opposite surface of the TFT substrate 2 from the liquid crystal layer 4 side. Furthermore, in the terminal region T of the TFT substrate 2, the integrated circuit chip 9, which is an electronic component, and the flexible printed board 24 are provided. The liquid crystal display device 1 shown in FIG. 1 is manufactured this way.

In the embodiment described above, the following advantages can be obtained.

(1) In this embodiment, the through holes 14 are formed in the CF substrate 3, and the first conductive members 15 for connecting the transparent conductive film 6 to the terminals 11 are provided in the through holes 14. The second conductive members 16 for connecting the transparent conductive film 6 to the terminals 11 are provided between the terminals 11 and the first conductive members 15, respectively. Here, the transparent conductive film 6 and the terminals 11 are electrically connected to each other through the first conductive member 15 and the second conductive member 16. Therefore, the terminals 11 and the transparent conductive film 6 can be connected without attaching a conductive tape on the step part formed between the transparent conductive film 6 and the terminals 11. As a result, the terminals 11 and the transparent conductive film 6 can be electrically connected to each other securely, and connection reliability can be improved.

(2) Three sides of the CF substrate 3 need not be formed narrower compared to the TFT substrate 2, and because only one side of the CF substrate 3 needs to be formed narrower than the TFT substrate 2 in order to form the terminal region T, the additional step for cutting the CF substrate 3 is not needed, thereby decreasing cost.

(3) Because the first conductive members 15 are provided in the respective through holes 14 formed in the CF substrate 3, and because the first conductive members 15 are embedded in the CF substrate 3, corrosion of the first conductive members 15 can be effectively prevented. Therefore, stable electric connection can be obtained between the transparent conductive film 6 and the terminals 11, and connection reliability can be improved.

(4) The second conductive member 16 is made of a conductive material containing the resin 41 and a conductive particle 40 coated with the resin 41. Because the conductive particle 40 is coated with the resin 41, corrosion of the second conductive member 16 can be effectively prevented. As a result, highly stable electric connection can be achieved between the transparent conductive film 6 and the terminals 11, and connection reliability can be further improved.

### Embodiment 2

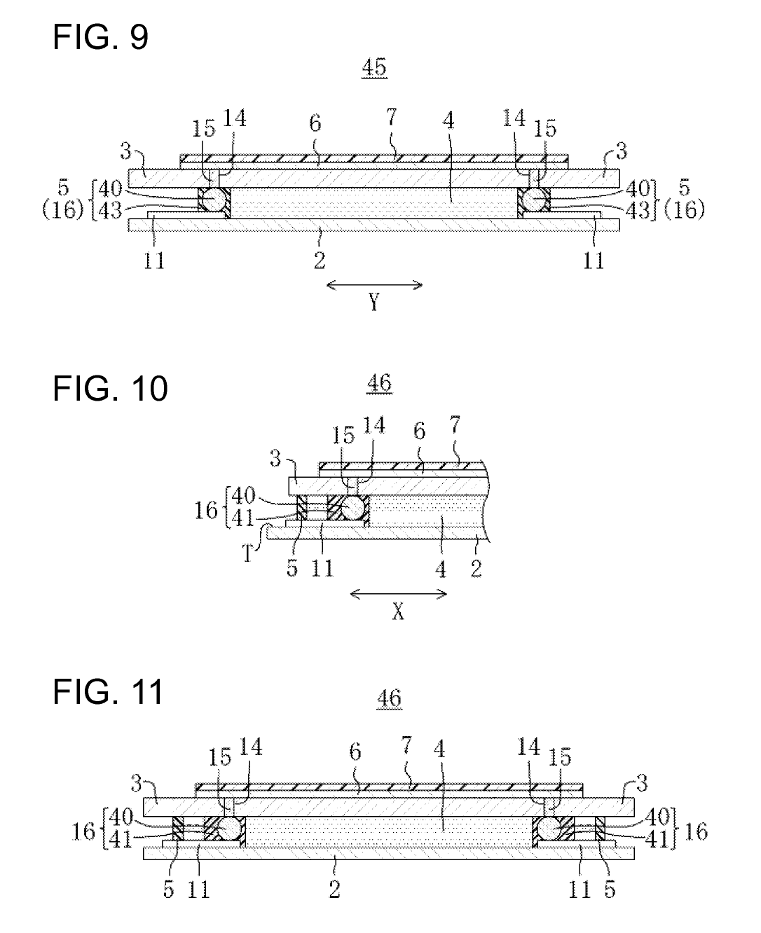

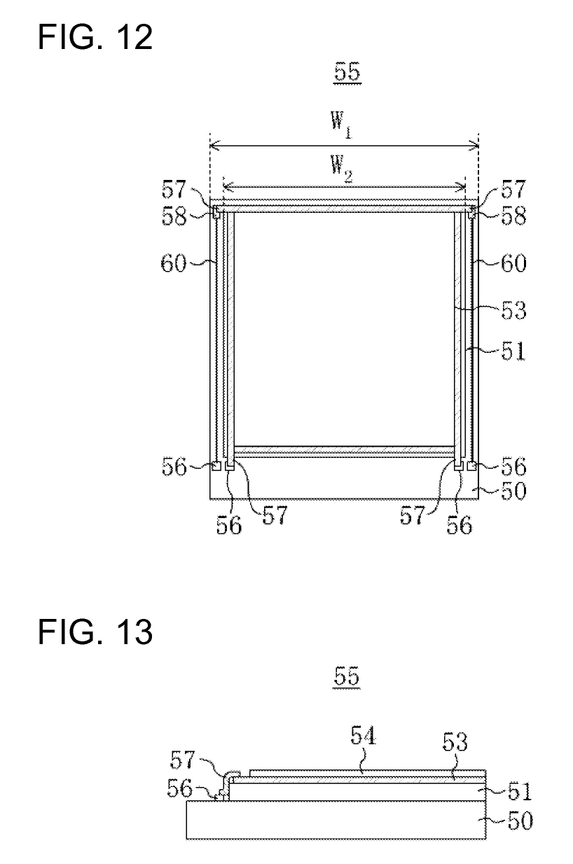

Next, Embodiment 2 of the present invention is explained. FIG. 8 is a cross-sectional view along the lengthwise direction of a liquid crystal display device with a touch panel according to Embodiment 2 of the present invention, and FIG. 9 is a cross-sectional view along the widthwise direction of the liquid crystal display device with a touch panel according to Embodiment 2 of the present invention. Components similar to those in the aforementioned Embodiment 1 are assigned the same reference characters, and explanation thereof is omitted. Further, because the overall configuration of the liquid crystal display device with a touch panel is similar to the configuration explained in Embodiment 1, further explanation thereof is omitted here.

A liquid crystal display device 45 with a touch panel according to this embodiment is characterized by the feature that the sealing material 5 also serves as the second conductive members 16. More specifically, instead of forming the second conductive members 16 from the conductive material containing the resin 41 and the conductive particle 40 coated with the resin 41, as shown in FIGS. 8 and 9, the conductive particles 40 are included in a sealing resin 43 (a ultraviolet curable thermosetting resin, for example) that constitutes the sealing material 5, and the second conductive member 16 is formed of the conductive material containing the sealing resin 43 and the conductive particle 40 coated with the sealing resin 43.

With such a configuration, in the lengthwise and widthwise directions X and Y of the liquid crystal display device 1, the second conductive members 16 can be relocated to the liquid crystal layer 4 side (i.e., the display region side) without forming the second conductive members 16 separately outside the sealing material 5 (i.e., the opposite side of the sealing material 5 from the liquid crystal layer 4 side).

In this case, because the through holes 14 and the first conductive members 15 provided in the through holes 14 need to be formed at locations corresponding to the sealing material 5 that also serves as the second conductive members 16, they are relocated to the liquid crystal layer 4 side (i.e., the display region side) compared to Embodiment 1, as shown in FIGS. 8 and 9.

In this embodiment described above, the following advantages can be obtained in addition to the aforementioned advantages (1) to (3).

(5) In this embodiment, the second conductive members 16 are made of the conductive material containing the sealing resin 43, which constitutes the sealing material 5, and the conductive particle 40 coated with the sealing resin 43, and the sealing material 5 also serves as the second conductive members 16. Because the second conductive member 16 can be relocated to the liquid crystal layer 4 side (i.e., the display region side), the area of the frame region F can be reduced.

(6) Because the conductive particle 40 are coated with the sealing resin 43, corrosion of the second conductive materials 16 can be effectively prevented. As a result, highly stable electrical connection can be obtained between the transparent conductive film 6 and the terminals 11, and connection reliability can be further improved.

(7) Because the sealing material 5 and the second conductive member 16 need not be formed separately, the number of components is reduced and cost can be decreased.

### Embodiment 3

Next, Embodiment 3 of the present invention is explained. FIG. 10 is a cross-sectional view along the lengthwise direction of a liquid crystal display device with a touch panel according to Embodiment 3 of the present invention, and FIG. 11 is a cross-sectional view along the widthwise direction of the liquid crystal display device with a touch panel according to Embodiment 3 of the present invention. Components similar to those in the aforementioned Embodiment 1 are assigned the same reference characters, and explanation thereof is omitted. Because the overall configuration of the liquid crystal display device with a touch panel is similar to the configuration explained in Embodiment 1, further explanation thereof is omitted here.

As shown in FIGS. 10 and 11, a liquid crystal display device 46 with a touch panel according to this embodiment is characterized by the features that the second conductive members 16 are disposed between the sealing material 5 and the liquid crystal layer 4 in the lengthwise direction X and in the widthwise direction Y of the liquid crystal display device 1. In other words, it is characterized by the second conductive members 16 being disposed inside the sealing material 5 in the lengthwise direction X and in the widthwise direction Y (i.e., the liquid crystal layer 4 side of the sealing material 5) of the liquid crystal display device 1.

In this case, because the through holes 14 and the first conductive members 15 in the through holes 14 need to be formed at locations corresponding to the second conductive members 16, as shown in FIGS. 10 and 11, they are relocated to the liquid crystal layer 4 side (i.e., the display region side) compared to Embodiment 2.

In this embodiment described above, the following advantages can be obtained in addition to the aforementioned advantages (1) to (4).

(8) In this embodiment, the second conductive members 16 are disposed between the sealing material 5 and the liquid crystal layer 4. Therefore, the second conductive members 16 can be relocated to the liquid crystal layer 4 side (i.e., the display region side), and the area of the frame region F can be reduced.

The aforementioned embodiments may be modified as follows.

In the aforementioned embodiment, a TFT-type liquid crystal display device was used as an example of the display device. However, the present invention can be applied to liquid crystal display devices such as a DUTY-type liquid crystal display device, a polysilicon-type liquid crystal display device, and the like, as well as to other display devices, such as an organic EL (electroluminescence) display device, a plasma display device, electronic paper, and the like.

### INDUSTRIAL APPLICABILITY

As described above, the present invention is useful for a display device provided with a capacitance-type touch panel.

### DESCRIPTION OF REFERENCE CHARACTERS

1 liquid crystal display device with touch panel
2 TFT substrate (first substrate)
3 CF substrate (second substrate)
4 liquid crystal layer (display medium layer)
5 sealing material
6 transparent conductive film for touch panel
11 terminal
14 through hole
15 first conductive member
16 second conductive member
40 conductive particle
41 resin
43 sealing resin
45 liquid crystal display device with touch panel
46 liquid crystal display device with touch panel

1. A display device with a touch panel, comprising:
a first substrate having a terminal to which an alternating current voltage for position detection is supplied;
a second substrate disposed to face said first substrate;
a display medium layer disposed between said first substrate and said second substrate;
a sealing material formed in a frame-shape disposed between said first substrate and said second substrate for attaching said first substrate and said second substrate together and for encapsulating said display medium layer; and
a transparent conductive film for a touch panel disposed on an opposite surface of said second substrate from a side of said display medium layer,
wherein said second substrate has a through hole and a first conductive member provided in said through hole for connecting said transparent conductive film to said terminal,
wherein a second conductive member for connecting said transparent conductive film to said terminal is provided between said terminal and said first conductive member, and
wherein said transparent conductive film and said terminal are electrically connected through said first conductive member and said second conductive member.

2. The display device with a touch panel according to claim 1, wherein said second conductive member is made of a conductive material containing a resin and a conductive particle coated with said resin.

3. The display device with a touch panel according to claim 2, wherein said resin is a sealing resin constituting said sealing material, and
wherein said sealing material also serves as said second conductive member.

4. The display device with a touch panel according to claim 1, wherein said second conductive member is disposed between said sealing material and said liquid crystal layer.

5. The display device with a touch panel according to claim 1, wherein said first conductive member is made of a conducive paste containing a conductive filler and a binder resin.

6. The display device with a touch panel according to claim 1, wherein said first conductive member is made of a metal.

7. The display device with a touch panel according to claim 1, wherein said display medium layer is a liquid crystal layer.
